(19) United States
(12) Patent Application Publication
(10) Pub. No.: US 2013/0095245 A1
(43) Pub. Date: Apr. 18, 2013

(54) Method of mixing reactive chemicals contained in separate containers on the vehicle surface to create a sealant

(71) Applicant: Sefik Tuncer Goren, Sunny Isles Beach, FL (US)

(72) Inventor: Sefik Tuncer Goren, Sunny Isles Beach, FL (US)

(21) Appl. No.: 13/651,378

(22) Filed: Oct. 12, 2012

Related U.S. Application Data
(60) Provisional application No. 61/546,933, filed on Oct. 13, 2011.

(51) Int. Cl. B05D 5/00

(52) U.S. Cl. 427/289; 427/299

(57) ABSTRACT

The method for applying a vehicle sealant that is mixed directly on the vehicle surface by the consumer. Traditionally consumers could directly apply the sealant out of one container onto the vehicle surface; however, when some reactive chemicals are bottled into one container they become solidified before it can even be used. With this method, chemicals are separated into different containers they will remain liquid, the consumer will mix the separated solutions on the surface of the vehicle to create the vehicle sealant.

### CROSS-REFERENCE TO RELATED APPLICATIONS

This claims priority to U.S. Provisional Application No. 61/546,933, titled “The process of mixing reactive chemicals contained in separate containers on the vehicle surface to create a sealant,” filed Oct. 13, 2011, which is hereby incorporated by reference in its entirety.

### BACKGROUND

There are vehicle paint sealants that exist in the market; however they are not as durable as desired. The main reason is because manufacturers are limited to the amount of chemicals (ingredients) that can be incorporated in one container. On the other hand consumers want a durable sealant that will protect their vehicle's paint long term.

The inventor invented a sealant that combined a wide variety of essential ingredients to he used. However, when all of these ingredients were combined, into a container within a few hours the mixture started reacting and ingredients solidified. To solve this problem, the inventor has invented a method where ingredients are separated into different containers, thereby allowing each container to remain inactive until the time of use. Where then the consumer will pour each of the containers onto the vehicle and mix on the surface to create a more durable vehicle sealant.

### SUMMARY

There are numerous chemicals in the market that contributes to enhance the durability of sealants; however, some of these chemicals cannot be combined within the same container due to their reactivity with one another. Also, they would create a non-homogeneous mixture.

The inventor has invented the method of mixing reactive chemicals contained in separate containers on the vehicle surface to create a sealant. The inventor has grouped compatible set of chemicals in separate containers, where the ingredients will remain homogeneous within its own container. At the time of application, the user will pour the liquids contained in separate containers on to the surface of the vehicle and will start mixing as they apply.

This way user will take advantage from wide variety of chemicals that will contribute and improve the efficacy of the sealant. During the application the chemical reaction will start and cure on the surface of the vehicle. Therefore the inventor's method enables the user to take advantage of a wide variety of ingredients which was not possible to be put together in one container. This method allows to increase dramatically the efficacy of the sealant.

### BRIEF DESCRIPTION OF THE DRAWINGS

The aforementioned and other aspects of the invention may best be understood by reference to the following description taken in conjunction with the accompanying drawings in which:

FIG. 1 illustrates a mixture of chemical ingredients which, due to their immiscible nature, become spoiled when mixed.

FIG. 2 illustrates that the invention groups the compatible ingredients in separate containers and brings them into a stable environment.

FIG. 3 illustrates that the user will mix the grouped chemicals directly on the vehicle surface, thus benefiting from a wide variety of ingredients in one application.

### DETAILED DESCRIPTION

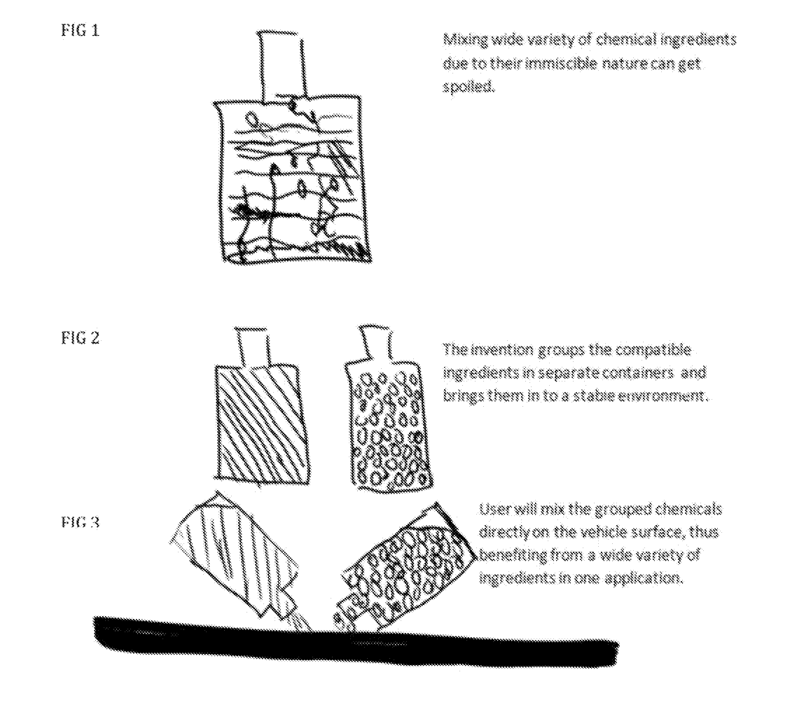

FIG. 1 illustrates a mixture of chemical ingredients which, due to their immiscible nature, become spoiled when mixed. FIG. 1 illustrates that when the reactive chemicals are confined within the same container they are solidified. Some chemicals can become spoiled when mixed together because some chemicals react to one another and solidify before the intended use period. If these chemicals react and solidify too soon then they will not be a usable product for consumer use. in this purpose of this invention, consumers should be able to apply the durable sealant to the vehicle surface at the desired time of application and due to the solidification of the reactive chemicals, this method was invented.

FIG. 2 illustrates that the invention groups compatible ingredients into separate containers and brings them into a stable environment. Ingredients are grouped in such a way that when that particular group is comprised of various ingredients they do not solidify, spoil or harden when confined within its own container. This is important because the intention of the product is to perform it intended use which is to act as a vehicle sealant. By grouping the products into separate containers, each container becomes homogeneous and stabilized; therefore, remains liquid and can be used by consumers.

FIG. 3 illustrates that the user will mix the grouped chemicals directly on the vehicle surface, thus benefiting from a wide variety of ingredients in one application to form a vehicle sealant. Since the ingredients in the separate containers are reactive, when combined together on the vehicle surface it activates a reaction which forms a solid barrier that is the vehicle sealant. This sealant application method is beneficial to consumers because it protects their vehicle with a longer lasting sealant.

In this invention where the process of mixing reactive chemicals contained in separate containers on the vehicle surface to create a sealant is intended for use by the following method:

First, the consumer must ensure that your vehicle surface is clean.

Second, consumer will then apply the first group of solution by pouring the first group of solutions onto a desired applicator and rubbing, it onto the vehicle surface.

Third, the consumer will apply an additional group of solution by pouring the second group of solutions onto a desired applicator and mixing it into the surface.

Fourth, if this is the final group of solutions then the consumer will continue onto the next step. However, if there are more groups of solutions then the consumer should repeat step three and proceed to the next step once all application product layers are filly utilized. Application product layers are formed by different groups of solutions. If there are two groups of solutions, then there are two application product layers.

Fifth, allow for products to react and create a homogenous mixture on the vehicle allowing optimum performance. At this stage the groups of layers formed by the different groups of solutions will cure together and develop the vehicle sealant

Finally, the consumer will buff-off the homogenous mixture residue using a soft micro fiber towel. Buffing off the homogeneous mixture residue will take of any excess product.

### ALTERNATIVE EMBODIMENTS

Reaction, curing and bonding times may vary. Application steps and products to create mixing on vehicle surface may vary. Can be used on either painted or unpainted surfaces. Vehicles includes but not limited to Car. Motorcycle, bus, truck, trailer, RV's, Motor Homes, Bikes, Bicycles, Boats, Motor Yachts, jet-skis, skis, snowmobiles, golf carts, planes, helicopter, jet, shuffles. Trains, and Tractor Equipment.

What is claimed is:

1. A method of applying reactive chemicals to a vehicle surface to create a sealant, the method comprising:
cleaning the vehicle surface;
applying, a first group of chemicals to the vehicle surface; and
applying a second group of chemicals to the vehicle surface.

2. The method of claim 1 wherein the first group of chemicals is applied with a desired applicator by rubbing the first group of chemicals into the vehicle surface.

3. The method of claim 1 wherein the second group of chemicals is applied with a desired applicator by mixing the second group of chemicals into the first group of chemicals on the vehicle surface.

4. The method of claim 1 wherein the first group of chemicals and the second group of chemicals react with each other to form a sealant.

5. The method of claim 1 further comprising:
allowing for the first group of chemicals and the second group of chemicals to react and create a homogenous mixture on the vehicle surface.

6. The method of claim 5 further comprising:
buffing-off the homogenous mixture.
